(19) United States
(12) Patent Application Publication
(10) Pub. No.: US 2024/0425733 A1
(43) Pub. Date: Dec. 26, 2024

(54) TWO-COMPONENT POLYURETHANE ADHESIVE

(71) Applicant: DDP SPECIALTY ELECTRONIC MATERIALS US, LLC, Wilmington, DE (US)

(72) Inventors: Sergio Grunder, FREIENBACH (CH); Maria Uzunska, FREIENBACH (CH)

(21) Appl. No.: 18/702,823

(22) PCT Filed: Nov. 10, 2022
(86) PCT No.: PCT/US2022/079590

§ 371 Date: Apr. 19, 2024

Related U.S. Application Data
(60) Provisional application No. 63/278,117, filed on Nov. 11, 2021.

(51) Int. Cl. C09J 175/08; C09J 11/04

(52) U.S. Cl. CPC C09J 175/08; C09J 11/04

(57) ABSTRACT

Provided herein is a two-component polyurethane adhesive.

### FIELD OF INVENTION

The present invention relates to the field of adhesives, in particular two-component polyurethane adhesives.

### BACKGROUND OF THE INVENTION

The automotive industry has seen a trend to reduce the weight of vehicles in the past decade. This trend has been mainly driven by regulations to reduce CO₂ emissions of the vehicle fleet. In recent years lightweight construction strategies have been further fueled by the increasing number of electrically driven vehicles. The combination of a growing automotive market and a growing market share of electrically driven vehicles leads to a strong growth

of number of electrically driven vehicles. To provide long driving ranges batteries with a high energy density are needed. Several battery strategies are currently followed with differing detailed concepts, but what all long range durable battery concepts have in common is that a thermal management is needed to deal with the heat generated during operation. To thermally

connect battery cells or modules to a cooling unit, thermal interface materials are needed.

Battery cells produce heat during charging and discharging operations. The cells need to be kept in the right operating temperature (preferably 25-40° C.) to optimise efficiency, and/or to avoid having a dangerous thermal runaway reaction. For these reasons, generally some form of active cooling is used. An efficient way is to pump cooled water/glycol mixtures through channels that cool the metal bottom plate on which the battery cells/modules are placed. In order not to have an insulating air film between the cells and cooling plate thermal interface materials are employed.

A common way to assemble the large batteries is to arrange battery cells into modules, and then place the modules in the battery pack. The thermal interface material (TIM) is placed between the module and a cooling plate. The modules are typically fixed with screws or other mechanical methods as the TIM does not typically provide much structural support. To increase the drive range of batteries, an energy density increase is desired. One way to increase the energy density is to eliminate the module level and bond the cells directly on the cooling plate. This is referred to as “cell-to-pack” (CTP). As the single cells cannot be manually fixed in place, in this arrangement, the TIM must provide structural support to bond the cells to the cooling plate. This kind of TIM is referred to as structural TIM or thermally conductive adhesive.

Thermally conductive adhesives are also employed to bond cells into modules, heat exchangers to a cooling plate, or other parts. A key requirement of the thermally conductive adhesives is a thermal conductivity greater than or equal to 1.5 W/mK. Further, a lap shear strength of >2 MPa is required. The cooling plate, and often also the cells—are made of aluminum. Therefore a good adhesion to aluminum is required.

While polyurethane based two-component (2K) based thermally conductive adhesives are well suited for thermally conductive adhesive applications in terms of mechanical properties, elongation at break, and curing kinetics, there remain some challenges. Particularly the poor adhesion to untreated aluminum substrates is not good. In order to reach high thermal conductivities, high amounts of thermally conductive fillers are needed. Aluminum hydroxide shows several advantages for formulating thermally conductive adhesives due to its low density, good thermal conductivity, and low cost. The problem with high levels of aluminum hydroxides in polyurethane adhesives is that the shelf-life is compromised due to undesired reactions of NCO groups with surface water or other hydroxy groups of the fillers.

### SUMMARY OF THE INVENTION

In a first aspect, the invention provides a two-component thermally conductive adhesive formulation comprising:
(A) a first part, comprising:
(a1) 7.5 to 25 wt %, based on the total weight of Part A, of a blocked polyurethane prepolymer which is the reaction product of a polyisocyanate with a phenol;
(a2) 3.5 to 15 wt %, based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2);
wherein Part (A) and/or Part (B) further comprise a thermally conductive filler, and Parts (A) and (B) are designed to be blended together to form the adhesive prior to use, and the concentration of thermally conductive filler in the adhesive is 60 to 80 wt %, based on the total weight of the adhesive.

In a second aspect, the invention provides a kit for a two-component thermally conductive adhesive formulation comprising:
(A) a first part, comprising:
(a1) 9 to 25 wt % based on the total weight of Part A, of a blocked polyurethane prepolymer which is the reaction product of a polyisocyanate with a phenol;
(a2) 3.5 to 15 wt % based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2);
wherein Part (A) and/or Part (B) further comprise a thermally conductive filler, and Parts (A) and (B) are designed to be blended together to form the adhesive prior to use, and the concentration of thermally conductive filler in the adhesive is 60 to 80 wt %, based on the total weight of the adhesive.

In a third aspect, the invention provides a method for bonding a battery cell to a substrate, the method comprising the steps:
(1) providing a two-component thermally conductive adhesive formulation comprising:
(A) a first part, comprising:
(a1) 9 to 25 wt % based on the total weight of Part A, of a blocked polyurethane prepolymer which is the reaction product of a polyisocyanate with a phenol;
(a2) 3.5 to 15 wt % based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2); wherein Part (A) and/or Part (B) further comprise a thermally conductive filler;
(2) mixing Part (A) and Part (B) to obtain an uncured adhesive, and the concentration of thermally conductive filler in the adhesive is 60 to 80 wt %, based on the total weight of the adhesive;
(3) applying the uncured adhesive to the battery cell, the substrate or both;
(4) bringing the battery cell and the substrate in to adhesive contact; and
(5) allowing the adhesive to cure.

In a fourth aspect, the invention provides a bonded assembly comprising a battery cell bonded to a substrate by means of an adhesive formed by mixing:
(A) a first part, comprising:
(a1) 9 to 25 wt % based on the total weight of Part A, of a blocked polyurethane prepolymer which is the reaction product of a polyisocyanate with a phenol;
(a2) 3.5 to 15 wt % based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2);
wherein Part (A) and/or Part (B) further comprise a thermally conductive filler, and Parts (A) and (B) are designed to be blended together to form the adhesive prior to use, and the concentration of thermally conductive filler in the adhesive is 60 to 80 wt %, based on the total weight of the adhesive.

### DETAILED DESCRIPTION OF THE INVENTION

The inventors have found that thermally conductive adhesives can be formulated with a combination of blocked-polyurethane resins with epoxy resins and silanes to offer i) a high thermal conductivity, ii) lap shear strengths >2 MPa, iii) good adhesion to aluminum substrates, and iv) good shelf-life (storage stability).

### Definitions and Abbreviations

DSC Differential scanning calorimetry
MDI 4,4′-Methylenebis(phenyl isocyanate)
HDI Hexamethylene diisocyanate
IPDI isophorone diisocyanate
PU polyurethane
SEC size exclusion chromatography
RH relative humidity

Equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

The adhesive of the invention is a two-component polyurethane adhesive, comprising an A Part and B Part. The A Part and the B Part may be packaged together as a kit. The A Part and the B Part are mixed together at an appropriate ratio, preferably 1:1 by volume, prior to use and then applied as soon as practicable to the substrate or substrates.

The A Part and the B Part will now be disclosed in more particular detail.

### A Part

The a Part Comprises:
(a1) 9 to 25 wt %, based on the total weight of Part A, of a blocked polyurethane prepolymer which is the reaction product of a polyisocyanate with a phenol;
(a2) 3.5 to 15 wt %, based on the total weight of Part A, of at least one aromatic epoxy resin;
(a3) at least one epoxy silane.

### Blocked Polyurethane Prepolymer (a1)

Part (A) of the adhesive composition comprises 9 to 25 wt %, more preferably 10 to 25 wt %, based on the total weight of Part A, of a blocked polyurethane prepolymer which is the reaction product of a polyisocyanate with a polyol, capped with a phenol, preferably 70-85 wt % aromatic polyisocyanate with 15-25 wt % phenol. Preferably the reaction is carried out with a tin catalyst.

The polyisocyanate may be aliphatic, aromatic, or a mixture, with aromatic polyisocyanates being preferred. Examples of aromatic polyisocyanates include methylene diphenyl diisocyanate (MDI), toluene diisocyanate (TDI), p-phenylene diisocyanate (PPDI), and naphthalene diisocyanate (NDI), all of which can be reacted with a polyol. Particularly preferred are methylene diphenyl diisocyanate (MDI) or toluene diisocyanate (TDI), reacted with a polyol.

The polyol preferably is a polyether polyol. The polyol may have two or more OH groups. Examples of polyether polyols include poly(alkylene oxide)diols, wherein the alkylene group is C₂-C₆, particularly preferably the alkylene group is C₂-C₄. Examples of suitable polyols include poly(ethylene oxide)diol, poly(propylene oxide)diol, poly(tetramethylene oxide)diol. Particularly preferred is poly(propylene oxide)diol, particularly poly(propylene glycol).

Particularly preferred is the reaction product of an aromatic diisocyanate with a polyether polyol, in particular those listed above, and then capping with a phenol.

The phenol used for capping is preferably a phenol of the following formula:

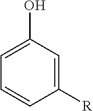

where R is a saturated or unsaturated C₁₅ chain, particularly preferably R is a saturated C₁₅ chain.

Particularly preferred is a polyisocyanate made by reacting TDI with a poly(propylene oxide)diol, in particular when the resulting polyisocyanate has an equivalent weight of at or about 950.

The phenol-containing compound typically has a linear hydrocarbon attached to the phenol group to provide some aliphatic characteristics to the compound. The linear hydrocarbon preferably includes 3 or more carbon atoms, more preferably 5 or more carbon atoms, even more preferably 8 or more carbon atoms, and most preferably 10 or more carbon atoms. The linear
hydrocarbon preferably includes at or about 50 or less carbon atoms, at or about 30 or less carbon atoms, at or about 24 or less carbon atoms, or at or about 18 or less carbon atoms. A particularly preferred phenol is cardanol.

In a preferred embodiment, the blocked polyurethane prepolymer is made by reacting methylene diphenyl diisocyanate (MDI) with a polyether polyol, in particular poly(propylene oxide)diol.

In a preferred embodiment, the blocked polyurethane prepolymer is made by reacting methylene toluene diisocyanate (TDI) with a polyether polyol, in particular poly(propylene oxide)diol.

In a particularly preferred embodiment, the blocked polyurethane prepolymer is made by reacting toluene diisocyanate with a polyether polyol, and has an NCO content of at or about 4-5% and an equivalent weight of at or about 500-1500 g/eq.

In another preferred embodiment, the blocked polyurethane prepolymer is made by reacting an aromatic polyisocyanate based on toluene diisocyanate with cardanol, preferably 70-85 wt % TDI-based polyisocyanate with 15-25 wt % cardanol. Preferably the reaction is carried out with a tin catalyst.

Molecular Weight data of the polyurethane prepolymers were measured by gel permeation chromatography (GPC) with a Malvern Viscothek GPC max equipment. EMSURE-THF (ACS, Reag. Ph EUR for analysis) was used as an eluent, PL GEL MIXED D (Agilent, 300*7.5 mm, 5 μm) was used as a column, and MALVERN Viscotek TDA was used as a detector.

The blocked polyurethane prepolymer is present at 9 to 25 wt %, more preferably 10 to 25 wt %, 12 to 18 wt %, particularly preferably at 13 to 15 wt %, based on the total weight of the A Part.

### Aromatic Epoxy Resin (a2)

Part A comprises 3.5 to 15 wt %, preferably 5 to 15 wt %, of an aromatic epoxy resin, based on the total weight of Part A. The aromatic epoxy resin is any epoxy resin based on a bis-phenol and epichlorohydrin. Examples of suitable bisphenols include bisphenol A, bisphenol AP, bisphenol AF, bisphenol B, bisphenol C, bisphenol E, bisphenol F, bisphenol M. In a preferred embodiment, the bisphenol is bisphenol A.

Part (A) comprises an aromatic epoxy resin. The aromatic epoxy resin is preferably a reaction product of a diphenol with epichlorohydrin. Examples of suitable diphenols include bisphenol A, bisphenol F, with bisphenol A being particularly preferred.

In a particularly preferred embodiment, the aromatic epoxy resin is a reaction product of epichlorohydrin and bisphenol A, having the following characteristics:

Typical properties

| Property | Value | Method |
|---|---|---|
| Epoxide equivalent weight (g/eq) | 176-185 | ASTM D-1652 |
| Epoxide % | 23.2-24.4 | ASTM D-1652 |
| Epoxide group content (mmol/kg) | 5400-5680 | ASTM D-1652 |
| Viscosity @ 25° C. (mPA · s) | 7000-10000 | ASTM D-445 |
| Hydrolyzable chloride content | 500 Max. | ASTM D-1726 |
| Water content (ppm) | 700 Max. | ASTM E-203 |
| Density @ 25° C. (g/ml) | 1.16 | ASTM D-4052 |
| Epichlorohydrin content (ppm) | 5 Max. | DowM 101321 |

In a preferred embodiment, the aromatic epoxy resin is a reaction product of epichlorohydrin and bisphenol A, having the following characteristics:

Typical properties

| Property | Value | Method |
|---|---|---|
| Epoxide equivalent weight (g/eq) | 176-185 | ASTM D-1652 |
| Epoxide % | 23.2-24.4 | ASTM D-1652 |
| Epoxide group content (mmol/kg) | 5400-5680 | ASTM D-1652 |
| Viscosity @ 25° C. (mPA · s) | 7000-10000 | ASTM D-445 |
| Hydrolyzable chloride content | 500 Max. | ASTM D-1726 |
| Water content (ppm) | 700 Max. | ASTM E-203 |
| Density @ 25° C. (g/ml) | 1.16 | ASTM D-4052 |
| Epichlorohydrin content (ppm) | 5 Max. | DowM 101321 |

at 6 to 10 wt %, based on the total weight of Part (A).

The aromatic epoxy resin preferably has a viscosity of less than or equal to 12,000 mPa·s, more preferably less than or equal to 11,000 mPa·s, particularly preferably less than or equal to 10,000 mPa·s, at 25° C. according to ASTM D-445.

The aromatic epoxy resin preferably has an epoxide equivalent weight of 150-250, more preferably 170-190, according to ASTM D-1652. [not sure if this is important]

In a particularly preferred embodiment, the aromatic epoxy resin is based on bisphenol A, has an epoxide equivalent weight of 176-185 (according to ASTM D-1652) and a viscosity of 7,000 to 10,000 mPa·s at 25° C. according to ASTM D-445. A suitable such epoxy is sold under the tradename DER 330.

The aromatic epoxy resin is present in the A Part at 3.5 to 15 wt %, 5-15 wt %, more preferably 6-10 wt %, based on the total weight of the A Part.

In a particularly preferred embodiment, the aromatic epoxy resin is based on bisphenol A, has an epoxide equivalent weight of 176-185 (according to ASTM D-1652) and is present at 6-10 wt %, based on the total weight of the A Part.

In use, Parts (A) and (B) are mixed prior to or simultaneously with application to a substrate. The concentration of the aromatic epoxy resin in the final, mixed adhesive can be calculated from the proportions of Parts (A) and (B) used to make the final mixed adhesive. In a preferred embodiment, Parts (A) and (B) are mixed in a 1:1 ratio by volume, in which case the concentration of the aromatic epoxy resin in the final adhesive will be half the value in Part (A).

### Epoxy Silane (a3)

Part A comprises an epoxy silane. The epoxy silane is any molecule of the general formula:

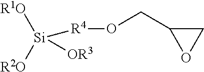

where R¹, R² and R³ are independently selected from C₁-C₃ alkyl, and R⁴ is a divalent organic radical.

In preferred embodiments, R¹, R² and R³ are independently selected from ethyl and methyl, with methyl being preferred, particularly when R¹, R² and R³ are methyl.

R⁴ is preferably selected from alkylene, preferably C₂-C₁₂ alkylene, more preferably C₂-C₆ alkylene, particularly preferably propylene.

In a particularly preferred embodiment, R¹, R² and R³ are methyl and the wavy bond is an n-propylene radical [(gamma-glycidoxypropyl) trimethoxy silane.]

The epoxy silane is preferably present in the A Part at 0.1 to 2 wt %, more preferably 0.25 to 1.5 wt %, particularly preferably 0.3 to 0.6 wt %, based on the total weight of the A Part.

In a particularly preferred embodiment, the epoxy silane is gamma-glycidoxypropyltrimethoxysilane at 0.2 to 0.75 wt %, more preferably 0.25 to 0.6 wt %, particularly preferably at or about 0.5 wt %, based on the total weight of Part (A).

### Thermally Conductive Filler

The thermally conductive filler is not particularly limited.

Suitable thermally conductive fillers are those that have a coefficient of thermal conductivity that is greater than 5 W/m° K, greater than 10 W/m° K, or greater than 15 W/m° K. Examples of thermally conductive fillers include alumina, alumina trihydrate or aluminum trihydroxide, silicon carbide, boron nitride, diamond, and graphite, or mixtures thereof. Particularly preferred are aluminium trihydroxide (ATH), and aluminium oxide, with ATH being the most preferred.

In a preferred embodiment, the thermally conductive filler has a broad particle size distribution characterized by a ratio of D90/D50 of at or about 3 or more. Particularly preferably the thermally conductive filler is ATH or aluminium oxide having a broad particle size distribution characterized by a ratio of D90/D50 of at or about 3 or more, most preferably ATH.

Also preferred are thermally conductive fillers having a bimodal particle size distribution. A bimodal distribution is when, for example, the ratio D90/D50 is at or about 3 or more, more preferably at or about 5 or more, more particularly preferably at or about 9 or more. For example, particles having a D₅₀ of 5 to 20 microns and a D₉₀ of 70 to 90 microns, particularly a D₅₀ of 7-9 microns and a D₉₀ of 78-82 microns. Particle size can be determined using laser diffraction. For ATH a suitable solvent is deionized water containing a dispersion aid, such as Na₄P₂O₇×10 H₂O, preferably at 1 g/l. Preferred are aluminium oxide and ATH having a bimodal distribution, particularly ATH.

The thermally conductive filler is preferably present in the final adhesive at a concentration that gives a thermal conductivity of at or about 1.5 W/mK or more. For example, this generally requires a concentration of thermally conductive filler of greater than 50 wt %, more preferably greater than 60 wt %, more particularly preferably greater than 70 wt %, based on the total weight of the adhesive. In a particularly preferred embodiment, the thermally conductive filler is present at greater than 80 wt %, based on the total weight of the adhesive. Preferably the thermally conductive filler content in the final adhesive is less than 93 wt %, as higher levels can affect the adhesive strength and impact resistance negatively. In a particularly preferred embodiment, the thermally conductive filler is present at 85-90 wt %, based on the total weight of the adhesive.

The thermally conductive filler may be present in Part (A), Part (B) or both. In a preferred embodiment it is present in both Part (A) and Part (B), as this reduces the amount of mixing required to properly distribute the thermally conductive filler when Parts (A) and (B) are mixed. Preferably it is present at similar or the same concentration in both Parts (A) and (B). In a particularly preferred embodiment it is present at 85-90 wt % in the final mixture of Parts (A) and (B), based on the total weight of the mixture. Preferably it is present both Parts (A) and (B) at 85 wt %, based on the weight of the relevant Part.

In a particularly preferred embodiment, the thermally conductive filler is ATH having a ratio D₉₀/D₅₀ of at or about 8 or more, used at a concentration of 85-89 wt % in both Parts (A) and (B), based on the total weight of Part (A) or Part (B).

### Part B

Part B comprises:
(b1) 8 to 18 wt %, preferably 11 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2).

### Nucleophilic Cross-Linker (b1)

Part B comprises 8 to 18 wt %, preferably 11 to 18 wt %, based on the total weight of Part B, of a nucleophilic cross-linker.

The nucleophilic cross-linker is preferably a di- or tri-amine, with triamines being preferred. The amine groups may be independently secondary or primary, with primary being preferred.

The nucleophilic cross-linker preferably has a molecular weight of 1,500 to 4,000 Da, more preferably 2,000 to 3,500 Da, with at or about 3,000 Da being particularly preferred.

The nucleophilic cross-linker preferably has a backbone based on poly(alkylene oxide)diols, particularly C₂-C₆ alkylene, more particularly C₂-C₄ alkylene, with C₃ alkylene being most preferred. Particularly preferably the backbone is based on a polyether of propylene glycol. Preferably it is a di- or tri-amine having the aforementioned backbone.

In a particularly preferred embodiment, the nucleophilic cross-linker is a triamine having primary amines for greater than 90% of amine groups, a molecular weight of at or about 3,000 Da, and a backbone based on a polyether of propylene glycol.

More particularly preferably, the nucleophilic cross-linker is a trifunctional polyether amine of approximately 3000 molecular weight,

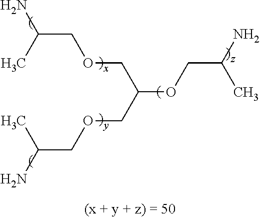 [SMILES: CC(N)COCC(COCC(C)N)OCC(C)N]

having the following characteristics:

Typical properties

| Property | Value | |
|---|---|---|
| Primary amine, % of total amine | >97 | |
| Total acetylatables | 0.96-1.06 | meq/g |
| Total amine | 0.90-0.98 | meq/g |
| Water | <0.25 | wt % |
| Amine hydrogen equivalent | 530 | g/eq |
| Viscosity @ 25° C. | 367 | cSt |
| Density @ 25° C. | 0.996 | g/ml |

The nucleophilic cross-linker is present in Part (B) at a concentration of 8 to 18 wt %, 11 to 18 wt %, more preferably 12 to 14 wt %, based on the total weight of Part (B).

In a particularly preferred embodiment, the nucleophilic cross-linker is a trifunctional polyether amine of approximately 3000 molecular weight,

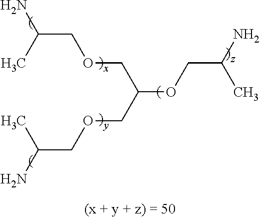 [SMILES: CC(N)COCC(COCC(C)N)OCC(C)N]

having the following characteristics:

Typical properties

| Property | Value | |
|---|---|---|
| Primary amine, % of total amine | >97 | |
| Total acetylatables | 0.96-1.06 | meq/g |
| Total amine | 0.90-0.98 | meq/g |
| Water | <0.25 | wt % |
| Amine hydrogen equivalent | 530 | g/eq |
| Viscosity @ 25° C. | 367 | cSt |
| Density @ 25° C. | 0.996 | g/ml |

at 11-14 wt %, based on the total weight of Part (B).

In use, Parts (A) and (B) are mixed prior to or simultaneously with application to a substrate. The concentration of the nucleophilic cross-linker in the final, mixed adhesive can be calculated from the proportions of Parts (A) and (B) used to make the final mixed adhesive. In a preferred embodiment, Parts (A) and (B) are mixed in a 1:1 ratio by volume, in which case the concentration of the nucleophilic cross-linker in the final adhesive will be half the value in Part

### (A)

### Catalyst (b2)

Part (B) comprises a catalyst capable of promoting the reaction of nucleophile (b1) with the blocked polyurethane prepolymer (a1) and the aromatic epoxy resin (a2).

The catalyst is preferably selected from Lewis bases and Lewis acids. Preferred are tertiary amines, including diazabicyclo[2.2.2]octane, tris-2,4,6-((dimethylamino)methyl) phenol, DMDEE (2,2′-Dimorpholinodiethylether), imidazoles, such as 4-methylimidazole), triethanolamine, polyethyleneimine.

Also suitable are organotin compounds, such as dioctyltindineodecanoate, and other metal catalysts such as tetrabutyltitanate, zirconium acetylacetonate, and bismuthneodecanoate.

Particularly preferred is diazabicyclo[2.2.2]octane in combination with tris-2,4,6-((dimethylamino)methyl) phenol.

The catalyst is preferably used at 0.05 to 0.6 wt %, more preferably 0.075 to 0.5 wt %, more particularly preferably at or about 0.5 wt %, based on the total weight of Part (B).

In a preferred embodiment, the catalyst is a combination of 0.2 to 0.6 wt % tris-2,4,6-((dimethylamino)methyl) phenol with 0.05 to 0.2 wt % diazabicyclo[2.2.2]octane, more particularly preferably 0.4 wt % tris-2,4,6-((dimethylamino)methyl) phenol with 0.1 wt % diazabicyclo[2.2.2]octane.

Optional ingredients in Part A and/or Part B

Parts (A) and (B) may additionally comprise other ingredients such as:
Plasticizers, such as esters of unsaturated fatty acids, in particular C₁₆-C₁₈ fatty acids, in particular methyl esters, tris(2-ethylhexyl)phosphate, and phosphate esters, such as tris(2-ethyhexyl)phosphate;
Stabilizers, such as polycaprolactone;
Dyes and colorants;
Fillers (other than the thermally conductive filler), such as carbon black, calcium carbonate, glass fibres, wollastonite;
Viscosity reducers, such as hexadecyltrimethoxysilane.

### Cured Thermally Conductive Adhesive

The invention also provides a cured thermally conductive adhesive, resulting from mixing Parts (A) and (B) and allowing curing to occur.

Parts (A) and (B) may be mixed in any proportion. Preferably the final concentrations of the ingredients fall within the following ranges after mixing (A) and (B), based on the total weight of the adhesive:

| | | More | More particularly |
|---|---|---|---|
| | Amount | preferred | preferred |
| Ingredient | (wt %) | (wt %) | (wt %) |
| (a1) blocked | 5-12.5 | 6-9 | 6.5-7.5 |
| polyurethane | | | |
| prepolymer | | | |
| (a2) aromatic | 2.5-7.5 | 3-5 | — |
| epoxy resin | | | |
| (a3) epoxy silane | 0.05-1 | 0.125-0.75 | 0.15-0.3 |
| (b1) nucleophilic | 5.5-9 | 6-7 | — |
| cross-linker | | | |
| (b2) catalyst | 0.05-0.6 | 0.025-0.5 | 0.5 |

### Application to Substrate

Parts (A) and (B) are mixed and can be applied to a substrate using known methods, such as a manual application system or in an automated way with a pump system using 20 I pails or 200 I drums or any other preferred container.

### Characteristics

The cured adhesive composition is characterized by a thermal conductivity, measured according to ASTM 5470-12 (as described in the Examples), of greater than or equal to 1.5 W/mK or more.

The cured adhesive composition preferably has a lap shear strength, after curing and resting for 7 days at 23° C., 50% relative humidity, according to DIN EN 1465:2009, as measured in the Examples, of greater than or equal to 1.8 MPa, more preferably greater than 2.2 MPa, more particularly preferably greater than 2.5 MPa.

The cured adhesive composition, after curing and resting for 7 days at 23° C., 50% relative humidity, has a failure mode of greater than 80% cohesive failure, more preferably greater than 90%, when measured according to the Examples.

The adhesive is also characterised by good storage stability, in that Part A shows an increase in viscosity of less than 80%, after storage for 2 weeks at room temperature.

The two-part composition cures at room temperature (preferably as characterized by changing from a paste to a solid within 24 hours after mixing).

### Battery Assembly and Method of Assembly

The invention also provides a battery assembly comprising battery modules fixed in place in the assembly by a cured adhesive composition and/or by mechanical fastening means, resulting from mixing Parts (A) and (B), such that the mixture, when cured, provides thermal conductivity between the cells
and the substrate.

Parts (A) and (B) are mixed in the desired ratio, and the mixture is applied, before curing, in a manner to separate the battery cells physically and electrically and to fix the cells in place on a substrate designed to cool the cells, such that the mixture, when cured, provides thermal conductivity between the cells and the substrate.

The thermal conductivity of the adhesive in the assembly, measured according to ASTM 5470-12 (as described in the Examples), is preferably 1.5 W/mK or more.

### Particularly Preferred Embodiments

The following are particularly preferred embodiments of the invention:

1. A two-component thermally conductive adhesive formulation comprising:
(A) a first part, comprising:
(a1) 9 to 25 wt %, based on the total weight of Part A, of a blocked polyurethane prepolymer which is the reaction product of a polyisocyanate with a phenol;
(a2) 3.5 to 15 wt %, based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2);
wherein Part (A) and/or Part (B) further comprise a thermally conductive filler, and Parts (A) and (B) are designed to be blended together to form the adhesive prior to use, and the concentration of thermally conductive filler in the adhesive is 60 to 80 wt %, based on the total weight of the adhesive.

2. A kit for a two-component thermally conductive adhesive formulation comprising:
(A) a first part, comprising:
(a1) 9 to 25 wt % based on the total weight of Part A, of a blocked polyurethane prepolymer which is the reaction product of a polyisocyanate with a phenol;
(a2) 3.5 to 15 wt % based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2);
wherein Part (A) and/or Part (B) further comprise a thermally conductive filler, and Parts (A) and (B) are designed to be blended together to form the adhesive prior to use, and the concentration of thermally conductive filler in the adhesive is 60 to 80 wt %, based on the total weight of the adhesive.

3. A method for bonding a battery cell to a substrate, the method comprising the steps:
(1) providing a two-component thermally conductive adhesive formulation comprising:
(A) a first part, comprising:
(a1) 9 to 25 wt % based on the total weight of Part A, of a blocked polyurethane prepolymer which is the reaction product of a polyisocyanate with a phenol;
(a2) 3.5 to 15 wt % based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2);
wherein Part (A) and/or Part (B) further comprise a thermally conductive filler;
(2) mixing Part (A) and Part (B) to obtain an uncured adhesive, and the concentration of thermally conductive filler in the adhesive is 60 to 80 wt %, based on the total weight of the adhesive;
(3) applying the uncured adhesive to the battery cell, the substrate or both;
(4) bringing the battery cell and the substrate in to adhesive contact; and
(5) allowing the adhesive to cure.

4. A bonded assembly comprising a battery cell bonded to a substrate by means of an adhesive formed by mixing:
(A) a first part, comprising:
(a1) 9 to 25 wt % based on the total weight of Part A, of a blocked polyurethane prepolymer which is the reaction product of a polyisocyanate with a phenol;
(a2) 3.5 to 15 wt % based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2);
wherein Part (A) and/or Part (B) further comprise a thermally conductive filler, and Parts (A) and (B) are designed to be blended together to form the adhesive prior to use, and the concentration of thermally conductive filler in the adhesive is 60 to 80 wt %, based on the total weight of the adhesive.

5. Any one preceding embodiment, wherein blocked polyurethane prepolymer is the reaction product of a polyisocyanate with a polyol, capped with a phenol.

6. Any one preceding embodiment, wherein the blocked polyurethane prepolymer comprises 70-85 wt % aromatic polyisocyanate (i.e. diisocyanate reacted with polyol) with 15-25 wt % phenol.

7. Embodiment 5 or 6, wherein the polyisocyanate is aliphatic, aromatic, or a mixture.

8. Embodiment 5 or 6, wherein the polyisocyanate is an aromatic polyisocyanate.

9. Any one preceding embodiment, wherein the blocked polyurethane prepolymer is made using a polyisocyanate selected from methylene diphenyl diisocyanate (MDI), toluene diisocyanate (TDI), p-phenylene diisocyanate (PPDI), and naphthalene diisocyanate (NDI).

10. Any one preceding embodiment, wherein the blocked polyurethane prepolymer is made using methylene diphenyl diisocyanate (MDI) or toluene diisocyanate (TDI).

11. Any one preceding embodiment, wherein the blocked polyurethane prepolymer is made using a polyether polyol.

12. Any one preceding embodiment, wherein the blocked polyurethane prepolymer is made using a poly(alkylene oxide)diol, wherein the alkylene group is C₂-C₆, particularly preferably the alkylene group is
C₂-C₄.

13. Any one preceding embodiment, wherein the blocked polyurethane prepolymer is made using poly(propylene oxide)diol, particularly poly(propylene glycol).

14. Any one preceding embodiment, wherein the blocked polyurethane prepolymer is made by reacting an aromatic diisocyanate with a polyether polyol, in particular those listed above, and then capping with a phenol.

15. Any one preceding embodiment, wherein the blocked polyurethane prepolymer is capped with a phenol of the following formula:

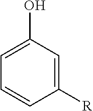

where R is a saturated or unsaturated C₁₅ chain, particularly preferably R is a saturated C₁₅ chain.

16. Any one preceding embodiment, wherein the blocked polyurethane prepolymer is capped with cardanol

17. Any one preceding embodiment, wherein the blocked polyurethane prepolymer is made by reacting TDI with a poly(propylene oxide)diol, in
particular when the resulting polyisocyanate has an equivalent weight of at or about 950.

18. Any one preceding embodiment, wherein the blocked polyurethane prepolymer is made by reacting methylene diphenyl diisocyanate (MDI)
with a polyether polyol, in particular poly(propylene oxide)diol.

19. Any one preceding embodiment, wherein the blocked polyurethane prepolymer is made by reacting toluene diisocyanate with a polyether polyol, and has an NCO content of at or about 4-5% and an
equivalent weight of at or about 500-1500 g/eq.

20. Any one preceding embodiment, wherein the blocked polyurethane prepolymer is made by reacting an aromatic polyisocyanate based on toluene diisocyanate with cardanol, preferably 70-85 wt % TDI-based
polyisocyanate with 15-25 wt % cardanol.

21. Any one preceding embodiment, wherein the blocked polyurethane prepolymer is present at 12 to 18 wt %, more preferably at 13 to 15 wt %, based on the total weight of Part A.

22. Any one preceding embodiment, wherein the aromatic epoxy resin is an epoxy resin based on a bis phenol and epichlorohydrin.

23. Any one preceding embodiment, wherein the aromatic epoxy resin is an epoxy resin based on bisphenol A, bisphenol AP, bisphenol AF, bisphenol B, bisphenol C, bisphenol E, bisphenol F, bisphenol M.

24. Any one preceding embodiment, wherein the aromatic epoxy resin is an epoxy resin based on bisphenol A.

25. Any one preceding embodiment, wherein the aromatic epoxy resin is a reaction product of epichlorohydrin and bisphenol A, having the following characteristics:

Typical properties

| Property | Value | Method |
|---|---|---|
| Epoxide equivalent weight (g/eq) | 176-185 | ASTM D-1652 |
| Epoxide % | 23.2-24.4 | ASTM D-1652 |
| Epoxide group content (mmol/kg) | 5400-5680 | ASTM D-1652 |
| Viscosity @ 25° C. (mPA · s) | 7000-10000 | ASTM D-445 |
| Hydrolyzable chloride content | 500 Max. | ASTM D-1726 |
| Water content (ppm) | 700 Max. | ASTM E-203 |
| Density @ 25° C. (g/ml) | 1.16 | ASTM D-4052 |
| Epichlorohydrin content (ppm) | 5 Max. | DowM 101321 |

26. Any one preceding embodiment, wherein the aromatic epoxy resin is used at 3.5 to 15 wt %, more preferably 6-10 wt %, based on the total weight of Part A.

27. Any one preceding embodiment, wherein the epoxy silane is a molecule of the general formula:

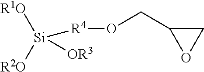

where R¹, R² and R³ are independently selected from C₁-C₃ alkyl, and R⁴ is a divalent organic radical.

28. Embodiment 27, wherein R¹, R² and R³ are independently selected from ethyl and methyl.

29. Embodiment 27 or 28, wherein R¹, R² and R³ are methyl.

30. Embodiment 27, 28 or 29, wherein R⁴ is selected from alkylene, preferably C₂-C₁₂ alkylene, more preferably C₂-C₆ alkylene, particularly preferably propylene.

31. Any one preceding embodiment, wherein the epoxy silane is (gamma-glycidoxypropyl) trimethoxy silane.

32. Any one preceding embodiment, wherein the epoxy silane is present in Part A at 0.1 to 2 wt %, more preferably 0.25 to 1.5 wt %, particularly preferably 0.3 to 0.6 wt %, based on the total weight of Part A.

33. Any one preceding embodiment, wherein the epoxy silane is gamma-glycidoxypropyltrimethoxysilane at 0.2 to 0.75 wt %, more preferably 0.25 to 0.6 wt %, particularly preferably at or about 0.5 wt %, based on the total weight of Part (A).

34. Any one preceding embodiment, wherein the thermally conductive filler is selected from those that have a coefficient of thermal conductivity that is greater than 5 W/m° K, greater than 10 W/m° K, or greater than 15 W/m° K.

35. Any one preceding embodiment, wherein the thermally conductive filler is selected from alumina, alumina trihydrate, aluminum trihydroxide, silicon carbide, boron nitride, diamond, and graphite, or mixtures thereof.

36. Any one preceding embodiment, wherein the thermally conductive filler is aluminium trihydroxide (ATH).

37. Any one preceding embodiment, wherein the thermally conductive filler is ATH having a broad particle size distribution characterized by a ratio of D₉₀/D₅₀ of at or about 3 or more.

38. Any one preceding embodiment, wherein the thermally conductive filler has a bimodal particle size distribution.

39. Any one preceding embodiment, wherein the thermally conductive filler has a ratio D₉₀/D₅₀ that is at or about 3 or more, more preferably at or about 5 or more, more particularly preferably at or about 9 or more.

40. Any one preceding embodiment, wherein the thermally conductive filler is ATH having a ratio D₉₀/D₅₀ that is at or about 3 or more, more preferably at or about 5 or more, more particularly preferably at or about 9 or more.

41. Any one preceding embodiment, wherein the thermally conductive filler is present in the final adhesive at a concentration that gives a thermal conductivity of at or about 1.5 W/mK or more.

42. Any one preceding embodiment, wherein the thermally conductive filler is present in the final adhesive at greater than 50 wt %, more preferably greater than 60 wt %, more particularly preferably greater than 70 wt %.

43. Any one preceding embodiment, wherein the thermally conductive filler is present in the final adhesive at greater than 80 wt %.

44. Any one preceding embodiment, wherein the thermally conductive filler is present in the final adhesive at 85-90 wt %.

45. Any one preceding embodiment, wherein the thermally conductive filler is ATH having a ratio D₉₀/D₅₀ of at or about 8 or more, used at a concentration of 85-89 wt % in both Parts (A) and (B), based on the total weight of Part (A) or Part (B).

46. Any one preceding embodiment, wherein the nucleophilic cross-linker is a di- or tri-amine.

47. Any one preceding embodiment, wherein the nucleophilic cross-linker is a triamine.

48. Any one preceding embodiment, wherein the nucleophilic cross-linker is a di- or tri-amine in which the amine groups are independently secondary or primary, with primary being preferred.

49. Any one preceding embodiment, wherein the nucleophilic cross-linker has a molecular weight of 1,500 to 4,000 Da, more preferably 2,000 to 3,500 Da, with at or about 3,000 Da being particularly preferred.

50. Any one preceding embodiment, wherein the nucleophilic cross-linker has a backbone based on poly(alkylene oxide)diols, particularly C₂-C₆ alkylene, more particularly C₂-C₄ alkylene, with C₃ alkylene being most preferred.

51. Any one preceding embodiment, wherein the nucleophilic cross-linker is based on a polyether of propylene glycol.

52. Any one preceding embodiment, wherein the nucleophilic cross-linker is a triamine having primary amines for greater than 90% of amine groups, a molecular weight of at or about 3,000 Da, and a backbone based on a polyether of propylene glycol.

53. Any one preceding embodiment, wherein the nucleophilic cross-linker is a trifunctional polyether amine of approximately 3000 molecular weight,

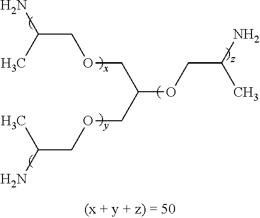 [SMILES: CC(N)COCC(COCC(C)N)OCC(C)N]

having the following characteristics:

Typical properties

| Property | Value | |
|---|---|---|
| Primary amine, % of total amine | >97 | |
| Total acetylatables | 0.96-1.06 | meq/g |
| Total amine | 0.90-0.98 | meq/g |
| Water | < 0.25 | wt % |
| Amine hydrogen equivalent | 530 | g/eq |
| Viscosity @ 25° C. | 367 | cSt |
| Density @ 25° C. | 0.996 | g/ml |

54. Any one preceding embodiment, wherein the nucleophilic cross-linker is present in Part (B) at a concentration of 8 to 18 wt %, more preferably 12 to 14 wt %, based on the total weight of Part (B).

55. Any one preceding embodiment, wherein the catalyst is selected from Lewis bases and Lewis acids.

56. Any one preceding embodiment, wherein the catalyst is selected from diazabicyclo[2.2.2]octane, tris-2,4,6-((dimethylamino)methyl) phenol,
DMDEE (2,2′-Dimorpholinodiethylether), imidazoles, such as 4-methylimidazole), triethanolamine, polyethyleneimine.

57. Any one preceding embodiment, wherein the catalyst is diazabicyclo[2.2.2]octane in combination with tris-2,4,6-((dimethylamino)methyl) phenol.

58. Any one preceding embodiment, wherein the catalyst is used at 0.05 to 0.6 wt %, more preferably 0.075 to 0.5 wt %, more particularly preferably at or about 0.5 wt %, based on the total weight of Part (B).

59. Any one preceding embodiment, wherein the catalyst is a combination of 0.2 to 0.6 wt % tris-2,4,6-((dimethylamino)methyl) phenol with 0.05 to 0.2 wt % diazabicyclo[2.2.2]octane, more particularly preferably 0.4 wt % tris-2,4,6-((dimethylamino)methyl) phenol with 0.1 wt % diazabicyclo[2.2.2]octane.

60. Any one preceding embodiment, wherein the cured adhesive composition is characterized by a thermal conductivity, measured according to ASTM 5470-12 (as described in the Examples), of greater than or equal to 1.5 W/mK or more.

61. Any one preceding embodiment, wherein the cured adhesive composition preferably has a lap shear strength, after curing and
resting for 7 days at 23° C., 50% relative humidity, according to DIN EN 1465:2009, as measured in the Examples, of greater than or equal to
2.5 MPa, more preferably greater than 2.6 MPa.

62. Any one preceding embodiment, wherein the cured adhesive composition, after curing and resting for 7 days at 23° C., 50% relative humidity, has a failure mode of greater than 80% cohesive failure, more preferably greater than 90%, when measured according to the Examples.

63. Any one preceding embodiment, wherein Part A shows an increase in viscosity of less than 80%, after 3 months at room temperature.

64. Any one preceding embodiment, wherein the two-part composition cures at room temperature (preferably as characterized by a change from paste to solid, after aging for 24 hours after mixing).

### Examples

TABLE 1
Ingredients

| Trademark or | |
|---|---|
| abbreviation | Chemistry |
| ATH bimodal | Bimodally distributed aluminium trihydroxide (ATH) |
| | Particle size (by laser diffraction in acetone): |
| | D₁₀ (micron) 0.5 |
| | D₅₀ (micron) 8 |
| | D₉₀ (micron) 80 |
| Epoxy silane | Gamma-glycidoxypropyltrimethoxysilane |
| Silane 2 | Hexadecyltrimethoxysilane |
| DER 330 | An epoxy resin that is a diglycidylether of bisphenol A |
| Polyamine-3000 | Polyetheramine which is a triamine of approximately |
| | 3,000 Da molecular weight: |
| | 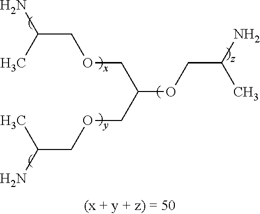 [SMILES: CC(N)COCC(COCC(C)N)OCC(C)N] |
| POLYAMINE | Polyetheramine which is a triamine of approximately |
| 440 | 440 Da molecular weight: |
| CaCO₃ | Precipitated calcium carbonate |
| FATTY ESTER | Methyl ester of unsaturated C₁₆₋₁₈ fatty acid |
| Phosphate | Tris(2-ethyhexyl)phosphate |
| Catalyst 1 | tris-2,4,6-dimethylaminomethyl phenol |
| Tin catalyst 1 | dioctyl tin dineodecanoate |
| DABCO LV33 | 33 wt % 1,4-diazabicyclo[2.2.2]octane in dipropylene |
| | glycol |
| Blocked | the reaction product of 77.85 wt % Desmodur E15 and |
| polyurethane | 22.1 wt % Cardanol. Reaction procedure: Cardanol and |
| prepolymer | Desmodur E15 are heated in a reactor to 60° C. The |
| | catalyst is then added. The reaction mixture is stirred |
| | for 45 min at 80° C. under an atmosphere of |
| | nitrogen and then for 10 min under vacuum. The |
| | colourless reaction product is then cooled to RT and |
| | transferred into a container. |
| Cardanol | cardanol |
| Prepolymer 1 | low viscosity blocked toluene diisocyanate (TDI) |
| | prepolymer based on TDI and polypropylene |
| | glycol with a functionality of 2. |
| Desmodur E21 | an aromatic polyisocyanate prepolymer based on |
| | diphenylmethane diisocyanate (MDI) |
| DESMODUR | An aromatic polyisocyanate based on toluene |
| E15 | diisocyanate |
| Diisocyanate 1 | Diphenylmethane diisocyanate |
| PTSI | p-toluene sulfonyl isocyanate |
| Triol 1 | A glycerine-initiated homopolymer polyether |
| | triol with an average molecular weight of 700 |
| Triol 2 | A polyether triol with an average molecular |
| | weight of 260 |
| Tin catalyst 2 | Dioctyltin dithioglycolate |
| Polycaprolactone | Polycaprolactone polyol diol initiated with neopentyl |
| diol | glycol of approximately 2,000 Da |

### Methods

Press-in Force: The press-in force was measured with a tensiometer (Zwick). The uncured adhesive was placed on a metal surface. An aluminium piston with 40 mm diameter was placed on top and the material was compressed to 5 mm (initial position). The material was then compressed to 0.3 mm with 1 mm/s velocity and force deflection curve is recorded. The force (N) at 0.5 mm thickness was then reported and considered as the press-in force.

Thermal conductivity: [Thermal conductivity was measured according to ASTM 5470-17 on a thermal interface material tester from ZFW Stuttgart. The A and B components are mixed in a volumetric ratio of 1:1 using side-by-side cartridges and a pneumatic application gun. The material is mixed with a helical static mixer with 10 mm diameter and 24 mixing elements. 2 mm thick plates were prepared and cured for 7d at 23° C., 50% rh. 30 mm diameter discs were cut from the cured plate and used of thermal conductivity tests. The thermal conductivity tests are performed in a pressure mode applying, 1, 2, 3, 5, and 10 bar pressure. The upper contact was heated to ca 40° C. and the lower contact to ca 10° C., resulting in a sample temperature of ca 25° C.

GPC: Molecular Weight data of the polyurethane prepolymers were measured by gel permeation chromatography (GPC) with a Malvern Viscothek GPC max equipment. EMSURE-THF (ACS, Reag. Ph EUR for analysis) was used as
an eluent, PL GEL MIXED D (Agilent, 300*7.5 mm, 5 μm) was used as a column, and MALVERN Viscotek TDA was used as a detector.

Preparation of formulations: The formulations were mixed on a planetary mixer or on a dual asymmetric centrifuge. In a first phase the liquid phases were mixed before the solid material is added to the formulation. The formulation was mixed for ca 30 min under vacuum before being filled into cartridges, pails, or drums.

Lap shear tests: aluminium substrates (from Novelis, AA6061 T6 1.92 mm MF noPT no lub, 140×25 mm, 1.9 mm thick) were used. The substrates were cleaned with isopropanol before use. The thermal interface material was applied on one substrate, before the second substrate was joined within 5 minutes. The thickness was adjusted to 1.0 mm, the overlap area was 25 mm×25 mm. The material was cured and rested for 7 days at 23° C., 50% relative humidity before the lap shear tests were performed. The lap shear samples were then mounted in a tensiometer and the lap shear tests were performed, using a pull speed of 10 mm/min. The force deflection curve was monitored and the strength at break was reported as lap shear strength.

Viscosity: Rheology measurements were performed on an Anton Paar MC 302 rheometer with a parallel plate geometry. 25 mm diameter plates were used, the gap was fixed at 0.5 mm. The thermal interface material was brought between the two plates and then a shear rate test was performed from 0.001 to 20 1/s. The viscosity at 10 1/s was reported.

Formulations were produced using the ingredients listed in Table 2.

TABLE 2
formulation and test data of the comparative and inventive examples.

| | CE1 | CE2 | CE4 | CE5 | CE6 | CE7 | CE8 |
|---|---|---|---|---|---|---|---|
| Version. | PU | PU + Epoxy | 0.5 epoxy | 0.5 epoxy | 4% epoxy | 5% Isobloc, | 7.5% Isoblock, |
| | | | | | | 2% DER | 3% DER |
| Formulation A - Component | A050 | A050 | A016 | A029 | A040 | A091 | A090 |
| Blocked polyurethane prepolymer | — | — | 14.75 | 14.75 | 14.75 | 5 | 7.5 |
| (Prepolymer 1) (wt %) | | | | | | | |
| Aromatic epoxy resin (DER 330) | — | — | 0.5 | 2.24 | 4.0 | 2 | 3 |
| (w %) | | | | | | | |
| Epoxy silane(wt %) | 0.5 | 0.5 | 0.5 | 0.5 | 0.5 | 0.5 | 0.5 |
| Thermally conductive filler | 77.85 | 77.85 | 76 | 76 | 73.5 | 79.25 | 77.25 |
| (ATH bimodal) (wt %) | | | | | | | |
| Precipitated calcium carbonate | 2 | 2 | 2 | 2 | 2 | 2 | 2 |
| (wt %) | | | | | | | |
| FATTY ESTER (wt %) | 2 | 2 | 2 | 1.76 | 2 | 5 | 4.25 |
| Tris(2-ethylhexyl)phosphate | 2 | 2 | 3 | 1.5 | 2 | 5 | 4.25 |
| (wt %) | | | | | | | |
| Green color paste (wt %) | 0.1 | 0.1 | 0.1 | 0.1 | 0.1 | 0.1 | 0.1 |
| Hexadecyltrimethoxysilane | 1 | 1 | 1.0 | 1.0 | 1.0 | 1 | 1 |
| (wt %) | | | | | | | |
| Polyester polyol | 0.15 | 0.15 | 0.15 | 0.15 | 0.15 | 0.15 | 0.15 |
| (Polycaprolactone diol) (wt %) | | | | | | | |
| Desmodur E21 (wt %) | 9.26 | 9.26 | — | — | — | | |
| Diisocyanate 1 (wt %) | 4.64 | 4.64 | — | — | — | | |
| p-Toluenesulfonyl Isocyanate | 0.5 | 0.5 | — | — | — | | |
| (wt %) | | | | | | | |
| Results A Component | | | | | | | |
| Viscosity at 10 s/s at 23° C. | 220 | 220 | 170 | 231 | 132 | 34 | 39 |
| (Pa · s) | | | | | | | |
| Viscosity at 10 s/s at 23° C. | 406 | 406 | | 270 after | 173 after | 32 | 39 |
| after 2 w RT storage (Pa · s) | | | | 7 months | 6 months | | |
| Formulation B - Component | B46 | B072 | B023 | B029 | B030 | B097 | B096 |
| POLYAMINE 3000 (Trifunctional | — | — | 13.17 | 16.30 | 13.17 | 7.86 | 12.21 |
| polyamine, 3000 MW) (wt %) | | | | | | | |
| POLYAMINE 440 (Trifunctional | — | — | — | — | 0.95 | — | — |
| polyamine, 440 MW)ss (wt %) | | | | | | | |
| Fatty ester (wt %) | 0.5 | 0.5 | — | — | 2 | 3.41 | 1.26 |
| Tris(2-ethylhexyl)phosphate | 0.5 | 0.5 | 0.53 | — | 2 | 3.4 | 1.2 |
| (wt %) | | | | | | | |
| Hexadecyltrimethoxysilane | 1 | 1 | 1.0 | 1.0 | 1.0 | 1 | 1 |
| (wt %) | | | | | | | |
| ATH bimodal (w %) | 81.47 | 80.47 | 82.65 | 80.05 | 82.23 | 81.68 | 81.68 |
| Precipitated calcium carbonate | 2 | 2 | 2 | 2 | 2 | 2 | 2 |
| (w %) | | | | | | | |
| tris-2,4,6-dimethylaminomethyl | — | — | 0.4 | 0.4 | 0.4 | 0.4 | 0.4 |
| phenol (wt %) | | | | | | | |
| DABCO LV33 (wt %) | — | — | 0.1 | 0.1 | 0.1 | 0.1 | 0.1 |
| Polyester polyol | 0.15 | 0.15 | 0.15 | 0.15 | 0.15 | 0.15 | 0.15 |
| (Polycaprolactone diol) (wt %) | | | | | | | |
| Triol 1 (wt %) | 14.37 | 6.56 | | | | | |
| Triol 2 (wt %) | — | 2.81 | | | | | |
| Tin catalyst 1 (wt %) | 0.01 | 0.01 | | | | | |
| DER 330 (wt %) | — | 6 | | | | | |
| Results B Component | | | | | | | |
| Viscosity at 10 s/s at 23° C. | 146 | 277 | 150 | 93 | 169 | 36 | 83 |
| (Pa · s) | | | | | | | |
| RESULTS (A & B Component 1:1 v/v) | | | | | | | |
| Thermal Conductivity λ_{eff} (W/mK) | 1.3 | | 1.7 | 1.5 | 1.7 | 2.0 | 1.8 |
| Lap Shear Strength (MPa) | 2.8 | 3.0 | 0.9 | 1.7 | 2.0 | 0.8 | 1.2 |
| Lap shear tests - failure mode | 100% AF | 100% AF | 80% AF | 40% AF | 30% AF | 90% CF | 90% CF |
| on aluminium | | | 20% CF | 60% CF | 70% CF | 10% AF | 10% AF |
| Tensile strength (MPa) | 1.7 | | 0.86 | 1.0 | 1.55 | 0.84 | 1.2 |
| E-modulus (MPa) | 10.6 | | 4.63 | 8.4 | 16.7 | 5.7 | 11.8 |
| Elongation at break (%) | 27 | | 26 | 34 | 25 | 13 | 16 |

| | E6 | E1 | E2 | E3 | E4 | E5 |
|---|---|---|---|---|---|---|
| Version. | | | | | | |
| Formulation A - Component | A089 | A036 | A041 | A056 | A057 | A055 |
| Blocked polyurethane prepolymer | 10 | 14.75 | 14.75 | 14.75 | 14.75 | 9.44 |
| (Prepolymer 1) (wt %) | | | | | | |
| Aromatic epoxy resin (DER 330) | 5 | 6 | 6 | 8 | 10 | 3.84 |
| (w %) | | | | | | |
| Epoxy silane(wt %) | 0.5 | 0.5 | 0.5 | 0.5 | 0.5 | 0.5 |
| Thermally conductive filler | 74.5 | 74.5 | 72.5 | 72.5 | 70.5 | 79.15 |
| (ATH bimodal) (wt %) | | | | | | |
| Precipitated calcium carbonate | 2 | 2 | 2 | 2 | 2 | 2 |
| (wt %) | | | | | | |
| FATTY ESTER (wt %) | 3.35 | 0.5 | 1.5 | 0.5 | 0.5 | 2 |
| Tris(2-ethylhexyl)phosphate | 3.4 | 0.5 | 1.5 | 0.5 | 0.5 | 1.82 |
| (wt %) | | | | | | |
| Green color paste (wt %) | 0.1 | 0.1 | 0.1 | 0.1 | 0.1 | 0.1 |
| Hexadecyltrimethoxysilane | 1 | 1.0 | 1.0 | 1.0 | 1.0 | 1.0 |
| (wt %) | | | | | | |
| Polyester polyol | 0.15 | 0.15 | 0.15 | 0.15 | 0.15 | 0.15 |
| (Polycaprolactone diol) (wt %) | | | | | | |
| Desmodur E21 (wt %) | | — | — | — | — | — |
| Diisocyanate 1 (wt %) | | — | — | — | — | — |
| p-Toluenesulfonyl Isocyanate | | — | — | — | — | — |
| (wt %) | | | | | | |
| Results A Component | | | | | | |
| Viscosity at 10 s/s at 23° C. | 48 | 356 | 148 | 263 | 203 | 222 |
| (Pa · s) | | | | | | |
| Viscosity at 10 s/s at 23° C. | 54 | 582 after | 162 after | 377 after | 244 after | 217 after |
| after 2 w RT storage (Pa · s) | | 6 months | 4 months | 3 months | 3 months | 3.5 months |
| Formulation B - Component | B095 | B031 | B031 | B065 | B066 | B064 |
| POLYAMINE 3000 (Trifunctional | 14.18 | 13.17 | 13.17 | 12.5 | 11.85 | 8.43 |
| polyamine, 3000 MW) (wt %) | | | | | | |
| POLYAMINE 440 (Trifunctional | 0.49 | — | — | 2.17 | 2.82 | 1.2 |
| polyamine, 440 MW)ss (wt %) | | | | | | |
| Fatty ester (wt %) | — | — | — | — | — | 1.0 |
| Tris(2-ethylhexyl)phosphate | — | 1.5 | 1.5 | — | — | 1.0 |
| (wt %) | | | | | | |
| Hexadecyltrimethoxysilane | 1 | 1.0 | 1.0 | 1.0 | 1.0 | 1.0 |
| (wt %) | | | | | | |
| ATH bimodal (w %) | 81.68 | 81.68 | 81.68 | 81.68 | 81.68 | 84.72 |
| Precipitated calcium carbonate | 2 | 2 | 2 | 2 | 2 | 2 |
| (w %) | | | | | | |
| tris-2,4,6-dimethylaminomethyl | 0.4 | 0.4 | 0.4 | 0.4 | 0.4 | 0.4 |
| phenol (wt %) | | | | | | |
| DABCO LV33 (wt %) | 0.1 | 0.1 | 0.1 | 0.1 | 0.1 | 0.1 |
| Polyester polyol | 0.15 | 0.15 | 0.15 | 0.15 | 0.15 | 0.15 |
| (Polycaprolactone diol) (wt %) | | | | | | |
| Triol 1 (wt %) | | | | | | |
| Triol 2 (wt %) | | | | | | |
| Tin catalyst 1 (wt %) | | | | | | |
| DER 330 (wt %) | | | | | | |
| Results B Component | | | | | | |
| Viscosity at 10 s/s at 23° C. | 160 | 158 | 158 | 161 | 157 | 206 |
| (Pa · s) | | | | | | |
| RESULTS (A & B Component 1:1 v/v) | | | | | | |
| Thermal Conductivity λ_{eff} (W/mK) | 1.8 | 1.5 | 1.7 | 1.3 | 1.6 | 2.0 |
| Lap Shear Strength (MPa) | 1.8 | 2.8 | 2.5 | 2.7 | 2.8 | 2.2 |
| Lap shear tests - failure mode | 100% CF | 100% CF | 100% CF | 100% CF | 100% CF | 80% CF |
| on aluminium | | | | | | 20% SCF |
| Tensile strength (MPa) | 1.9 | 2.0 | 1.8 | 2.65 | 2.84 | 2.5 |
| E-modulus (MPa) | 21.9 | 22.7 | 19.2 | 33.4 | 35.3 | 32 |
| Elongation at break (%) | 17 | 16 | 20 | 14 | 14 | 8 |

Lap shear tests were performed on 6061 aluminium substrates that were cleaned with isopropanol. AF: adhesive failure. CF: cohesive failure.

1. A two-component thermally conductive adhesive formulation comprising:
(A) a first part, comprising:
(a1) 9 to 25 wt %, based on the total weight of Part A, of a blocked polyurethane prepolymer which is the reaction product of a polyisocyanate with a phenol;
(a2) 3.5 to 15%, based on the total weight of Part A, of at least one aromatic epoxy resin;
(a3) at least one epoxy silane;
(B) a second part, comprising:
(b1) 8 to 18 wt %, based on the total weight of Part B, of a nucleophilic cross-linker capable of reacting with the blocked polyurethane prepolymer (a1) and the aromatic epoxy resin (a2);
(b2) a catalyst capable of promoting the reaction of nucleophile (b1) with the blocked polyurethane prepolymer (a1) and the aromatic epoxy resin (a2);
wherein Part (A) and/or Part (B) further comprise a thermally conductive filler, and Parts (A) and (B) are designed to be blended together to form the adhesive prior to use, and the concentration of thermally conductive filler in the adhesive formulation is 60 to 80 wt %, based on the total weight of the adhesive formulation.

2. (canceled)

3. (canceled)

4. (canceled)

5. The formulation of claim 1, wherein blocked polyurethane prepolymer is the reaction product of a polyisocyanate with a polyol, capped with a phenol.

6. The formulation of claim 1, wherein the blocked polyurethane prepolymer comprises 70-85 wt % aromatic polyisocyanate with 15-25 wt % phenol, based on the total weight of the prepolymer.

7. The formulation of claim 6, wherein the polyisocyanate is aliphatic, aromatic, or a mixture thereof.

8. The formulation of claim 6, wherein the polyisocyanate is an aromatic polyisocyanate.

9. The formulation of claim 1, wherein the blocked polyurethane prepolymer is made using a polyisocyanate selected from methylene diphenyl disocyanate (MDI), toluene disocyanate (TDI), p-phenylene diisocyanate (PPDI), and naphthalene diisocyanate (ND1).

10. The formulation of claim 1, wherein the blocked polyurethane prepolymer is made using methylene diphenyl diisocyanate (MDI) or toluene diisocyanate (TDI).

11. The formulation of claim 1, wherein the blocked polyurethane prepolymer is made using a polyether polyol.

12. The formulation of claim 1, wherein the blocked polyurethane prepolymer is made using a poly(alkylene oxide)diol, wherein the alkylene group is C2-C6.

13. The formulation of claim 1, wherein the blocked polyurethane prepolymer is made using poly(propylene oxide)diol.

14. The formulation of claim 1, wherein the blocked polyurethane prepolymer is made by reacting an aromatic diisocyanate with a polyether polyol, and then capping with a phenol.

15. The formulation of claim 1, wherein the blocked polyurethane prepolymer is capped with a phenol of the following formula: 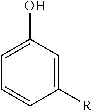
where R is a saturated or unsaturated C15 chain.

16. The formulation of claim 1, wherein the blocked polyurethane prepolymer is capped with cardanol.

17. The formulation of claim 1, wherein the blocked polyurethane prepolymer is made by reacting TDI with a poly(propylene oxide)diol wherein the resulting polyisocyanate has an equivalent weight of at or about 950.

18. The formulation of claim 1, wherein the blocked polyurethane prepolymer is made by reacting methylene diphenyl diisocyanate (MDI) with a polyether polyol.

19. The formulation of claim 1, wherein the blocked polyurethane prepolymer is made by reacting toluene diisocyanate with a polyether polyol, and has an NCO content of at or about 4-5% and an equivalent weight of at or about 500-1500 g/eq.

20. The formulation of claim 1, wherein the blocked polyurethane prepolymer is made by reacting an aromatic polyisocyanate based on toluene diisocyanate with cardanol.

21. The formulation of claim 1, wherein the blocked polyurethane prepolymer is present at 12 to 18 wt%, based on the total weight of Part A.

22. The formulation of claim 1, wherein the aromatic epoxy resin is an epoxy resin based on a bis-phenol and epichlorohydrin.

23. The formulation of claim 1, wherein the aromatic epoxy resin is an epoxy resin based on bisphenol A, bisphenol AP, bisphenol AF, bisphenol B, bisphenol C, bisphenol E, bisphenol F, or bisphenol M.

24. The formulation of claim 1, wherein the aromatic epoxy resin is an epoxy resin based on bisphenol A.

25-64. (canceled)
